(19) United States
(12) Patent Application Publication
(10) Pub. No.: US 2012/0229036 A1
(43) Pub. Date: Sep. 13, 2012

(54) LIQUID CRYSTAL DISPLAY DEVICE

(75) Inventors: Satoshi TAKAHASHI, Isumi (JP); Satoshi Tanaka, Chiba (JP)

(73) Assignee: Hitachi Displays, Ltd.

(21) Appl. No.: 13/410,324

(22) Filed: Mar. 2, 2012

(30) Foreign Application Priority Data
Mar. 7, 2011 (JP) 2011-049065

(51) Int. Cl. H05B 37/02

(52) U.S. Cl. 315/192

(57) ABSTRACT

The liquid crystal display device is a display device, having; a display panel; a backlight having light emitting diode columns; and an LED driver IC for driving the light emitting diode columns, wherein the light emitting diode columns are formed of a number of light emitting diodes, the LED driver IC controls the voltage applied to said light emitting diode columns so that the current that flows through a light emitting diode column and is inputted into the LED driver IC is a predetermined constant current, the display device further has a current amplifying unit for amplifying the reference current inputted into the LED driver IC and allowing the amplified reference current to flow through a light emitting diode column, and the current inputted into the LED driver IC and the current amplified by the current amplifying unit flow through a light emitting diode column.

### CROSS-REFERENCE TO RELATED APPLICATION

The present application claims priority over Japanese application JP 20111-049065 filed on Mar. 7, 2011, the contents of which are hereby incorporated into this application by reference.

### BACKGROUND OF THE INVENTION

(1) Field of the Invention

The present invention relates to a liquid crystal display device, and in particular, to a driving circuit for white light emitting diodes that form the light source for a backlight.

(2) Description of the Related Art

TFT (thin film transistor)-type liquid crystal display devices using thin film transistors (TFTs) as active elements are widely used as a display device, such as for personal computers. These liquid crystal display devices are provided with a liquid crystal display panel, a backlight for illuminating the liquid crystal display panel, a driving circuit for driving the liquid crystal display panel, and a display control circuit.

In recent years, LED backlights that use white light emitting diodes for the light source for the backlight have been adopted in a liquid crystal display device. Such liquid crystal display devices that adopt an LED backlight have an LED driving circuit for driving an LED backlight, and the LED driving circuit current drives a number of white diodes connected in series.

Patent Document 1: Japanese Unexamined Patent Publication 2009-175382

### SUMMARY OF THE INVENTION

In liquid crystal display devices where an LED backlight is adopted, it is effective to reduce the number of white light emitting diodes used for the light source in order to lower the cost. In the case where the number of white light emitting diodes is small, the brightness of the LED backlight lowers, and therefore, it is necessary to compensate for the reduction in the brightness by increasing the current that flows through the white light emitting diodes.

Meanwhile, the LED driving circuit has an LED driver IC, but the LED driver ICs that are currently available in the market cannot allow a target current to flow through the white light emitting diodes.

Therefore, in the case where an LED driver IC that is currently available is used and the number of white light emitting diodes needs to be reduced in order to lower the cost, such a problem arises that the current that flows through the white light emitting diodes cannot be increased in order to compensate for the reduction in the brightness.

The present invention is provided in order to solve the above-described problem with the prior art, and an object of the present invention is to provide a technology that makes it possible to allow a target current to flow through the light emitting diodes using an LED driver IC that is currently available in the market.

The above-described and other objects, as well as novel features of the present invention, will be clarified from the descriptions of the present specification and the accompanying drawings.

The typical examples disclosed in the present specification are briefly described as follows:

(1) A display device is provided with: a display panel; a backlight having light emitting diode columns; and an LED driver IC for driving the above-described light emitting diode columns, wherein the above-described light emitting diode columns are formed of a number of light emitting diodes, the above-described LED driver IC controls the voltage applied to the above-described light emitting diode columns so that the current that flows through a light emitting diode column and is inputted into the above-described LED driver IC becomes a predetermined constant current, the display device is further provided with a current amplifying unit for amplifying the reference current inputted into the above-described LED driver IC and allowing the amplified reference current to flow through a light emitting diode column, and the current inputted into the above-described LED driver IC and the current amplified by the above-described current amplifying unit flow through a light emitting diode column.
(2) In the display device according to (1), the above-described LED driver IC boosts the input voltage, which is then inputted into one end of the above-described light emitting diode columns, the above-described current amplifying unit has: a first current mirror circuit having a first transistor and a second transistor; and a second current mirror circuit having a third transistor and a fourth transistor, the other end of the above-described light emitting diode columns is connected to the above-described fourth transistor, part of the current that flows through a light emitting diode column is inputted into the above-described LED driver IC and the rest of the current that flows through the light emitting diode column flows through the above-described fourth transistor, the current that flows through the above-described first transistor is inputted into the above-described LED driver IC, the above-described second transistor allows a current that corresponds to the current that flows through the above-described first transistor to flow through the above-described third transistor, a current that corresponds to the current that flows through the above-described third transistor flows through the above-described fourth transistor, and the above-described LED driver IC controls the voltage applied to the above-described light emitting diode columns so that the current inputted into the above-described LED driver IC through the above-described first transistor and the current inputted into the above-described LED driver IC through a light emitting diode column become constant currents.
(3) The display device according to (1) is further provided with: a coil; and a switching transistor for turning on and off the current that flows through the above-described coil, wherein the above-described LED driver IC has a constant current control unit and a switching unit, the above-described switching unit turns on and off the above-described switching transistor and boosts the input voltage, which is then inputted into one end of the above-described light emitting diode columns, the above-described current amplifying unit has: a first current mirror circuit having a first transistor and a second transistor; and a second current mirror circuit having a third transistor and a fourth transistor, the other end of the above-described light emitting diode columns is connected to the above-described fourth transistor, part of the current that flows through a light emitting diode column is inputted into the above-described constant current control unit and the rest of the current that flows through the light emitting diode column flows through the above-described fourth transistor, the current that flows through the above-described first transistor is inputted into the above-described constant current control unit, the above-described second transistor allows a current that corresponds to the current that flows through the above-described first transistor to flow through the above-described third transistor, a current that corresponds to the current that flows through the above-described third transistor flows through the above-described fourth transistor, the above-described switching unit turns on and off the above-described switching transistor under the control of the above-described constant current control unit and controls the voltage inputted into one end of the above-described light emitting diode columns, and the above-described constant current control unit controls the above-described switching unit so that the current inputted into the above-described constant current control unit through the above-described first transistor and the current inputted into the above-described constant current control unit through a light emitting diode column become constant currents.
(4) In the display device according to (1), the above-described LED driver IC boosts the input voltage, which is then inputted into one end of the above-described light emitting diode columns, the above-described current amplifying unit has: a first current mirror circuit having a first transistor and a second transistor; and a second current mirror circuit having a third transistor and fourth to (4+k)th transistors that are connected in parallel when k is an integer of 1 or more, the other end of the above-described light emitting diode columns is connected to the above-described fourth to (4+k)th transistors, part of the current that flows through a light emitting diode column is inputted into the above-described LED driver IC and the rest of the current that flows through the light emitting diode column flows through the above-described fourth to (4+k)th transistors, the current that flows through the above-described first transistor is inputted into the above-described LED driver IC, the above-described second transistor allows a current that corresponds to the current that flows through the above-described first transistor to flow through the above-described third transistor, a current that corresponds to the current that flows through the above-described third transistor flows through the above-described fourth to (4+k)th transistors, and the above-described

LED driver IC controls the voltage applied to the above-described light emitting diode columns so that the current inputted into the above-described LED driver IC through the above-described first transistor and the current inputted into the above-described LED driver IC through a light emitting diode column become constant currents.

(5) The display device according to (1) is further provided with: a coil; and a switching transistor for turning on and off the current that flows through the above-described coil, wherein the above-described LED driver IC has a constant current control unit and a switching unit, the above-described switching unit turns on and off the above-described switching transistor and boosts the input voltage, which is then inputted into one end of the above-described light emitting diode columns, the above-described current amplifying unit has: a first current mirror circuit having a first transistor and a second transistor; and a second current mirror circuit having a third transistor and fourth to (4+k)th transistors that are connected in parallel when k is an integer of 1 or more, the other end of the above-described light emitting diode columns is connected to the above-described fourth to (4+k)th transistors, part of the current that flows through a light emitting diode column is inputted into the above-described constant current control unit and the rest of the current that flows through the light emitting diode column flows through the above-described fourth to (4+k)th transistors, the current that flows through the above-described first transistor is inputted into the above-described constant current control unit, the above-described second transistor allows a current that corresponds to the current that flows through the above-described first transistor to flow through the above-described third transistor, a current that corresponds to the current that flows through the above-described third transistor flows through the above-described fourth to (4+k)th transistors, the above-described switching unit turns on and off the above-described switching transistor under the control of the above-described constant current control unit and controls the voltage inputted into one end of the above-described light emitting diode columns, and the above-described constant current control unit controls the above-described switching unit so that the current inputted into the above-described constant current control unit through the above-described first transistor and the current inputted into the above-described constant current control unit through a light emitting diode column become constant currents.

The effects that are gained by the representative inventions disclosed in the present specification are briefly described as follows.

According to the present invention, it is possible to use an LED driver IC that is currently available in the market to allow a target current to flow through the light emitting diodes.

### BRIEF DESCRIPTION OF THE DRAWINGS

FIG. 1 is a block diagram schematically showing the structure of the liquid crystal display device according to the embodiments of the present invention;

FIG. 2 is a circuit diagram showing the circuit structure of the LED driving circuit according to the first embodiment of the invention;

FIG. 3 is a circuit diagram showing the circuit structure of the LED driving circuit according to the second embodiment of the invention;

FIG. 4 is a circuit diagram showing the circuit structure of a conventional LED driving circuit; and

FIG. 5 is a circuit diagram showing the circuit structure in the case where a large current flows through the light emitting diodes in a conventional LED driving circuit.

### DESCRIPTION OF THE EMBODIMENTS

### Best Mode for Carrying Out the Invention

In the following, the preferred embodiments of the present invention are described in detail in reference to the drawings.

Here, the same symbols are attached to the components having the same functions throughout the diagrams for illustrating the embodiments, and the descriptions thereof are not repeated. In addition, the following embodiments are not for limiting the interpretation of the scope of the present invention.

### First Embodiment

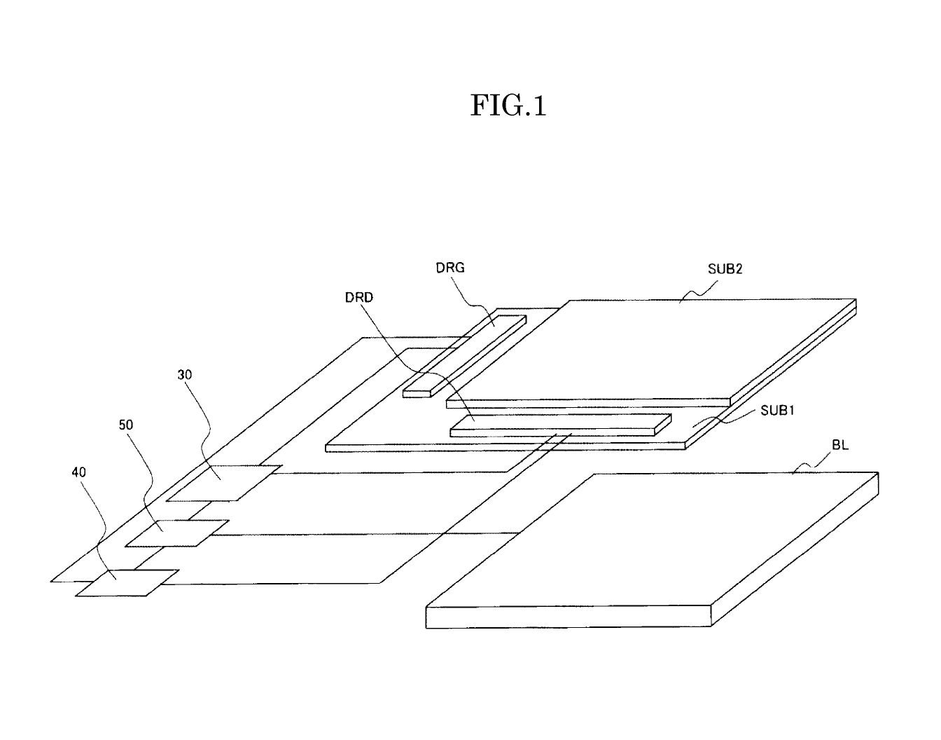

FIG. 1 is a block diagram schematically showing the structure of the liquid crystal display device according to the first embodiment of the present invention.

The liquid crystal display device according to the present embodiment has a liquid crystal display panel and a backlight (BL) directly behind the panel. The liquid crystal display panel has a first substrate (SUB1) and a second substrate (SUB2) where thin film transistors, pixel electrodes and the like are formed on the first substrate (SUB1) and a light blocking film, a color filter and the like are formed on the second substrate (SUB2). Here, counter electrodes are formed on the first substrate (SUB1) in the case where the liquid crystal display panel is of a lateral electric field type, such as of the IPS type, and are formed on the second substrate (SUB2) in the case where the liquid crystal display panel is of a vertical electric field type, such as of the VA type.

The liquid crystal display panel is formed by pasting the first substrate (SUB1) and the second substrate (SUB2) together with a sealing material in between, and injecting and sealing liquid crystal in the space between the first substrate (SUB1) and the second substrate (SUB2). In addition, polarizing plates (not shown) are provided on the outside of the first substrate (SUB1) and the second substrate (SUB2), respectively. Here, the present invention does not directly relate to the structure of the liquid crystal display panel, and therefore, the descriptions of the structure of the liquid crystal display panel are omitted.

A video line driving circuit (DRD) is provided in the periphery along one long side of the first substrate (SUB1), and a scanning line driving circuit (DRG) is provided in the periphery along one short side of the first substrate (SUB1).

The video line driving circuit (DRD) and the scanning line driving circuit (DRG) are controlled and driven by a display control circuit (timing controller) 30.

Though a case where the video line driving circuit (DRD) and the scanning line driving circuit (DRG) are formed of two semiconductor chips, respectively, is described in reference to FIG. 1, the video line driving circuit (DRD) and the scanning line driving circuit (DRG) may be formed of one semiconductor chip, respectively.

The backlight (BL) has white light emitting diodes (not shown) as the light source, and these white light emitting diodes are driven by the LED driving circuit 50. In addition, a control signal is inputted into the LED driving circuit 50 from the display control circuit 30.

The power supply circuit 40 supplies a voltage for driving each pixel to the video line driving circuit (DRD) and the scanning line driving circuit (DRG), and at the same time, supplies an input voltage (Vin) to the LED driving circuit 50.

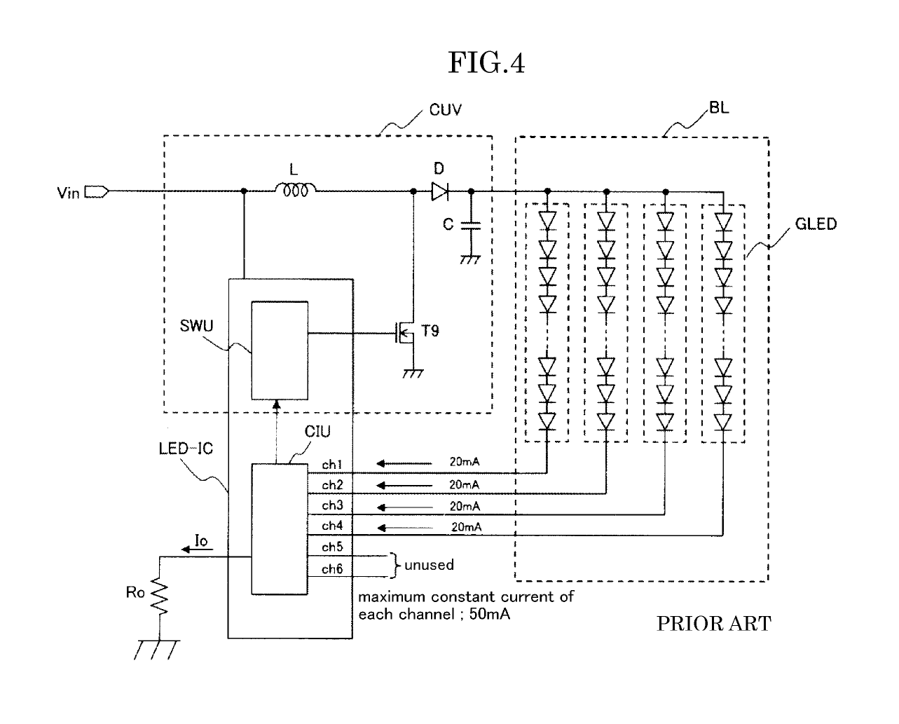

FIG. 4 is a circuit diagram showing the circuit structure of a conventional LED driving circuit. First, the problems with the conventional LED driving circuit are described in reference to FIG. 4.

In FIG. 4, LED-IC is an LED driver formed of a semiconductor integrated circuit, BL is a backlight, and the LED driver (LED-IC) has a switching unit (SWU) and a constant current control unit (CIU). In addition, the backlight (BL) has a number of groups of light emitting diodes (GLED). Here, the groups of light emitting diodes (GLED) are formed of a number of white light emitting diodes. The groups of light emitting diodes (GLED) may be referred to as light emitting diode columns or a light emitting diode array.

Furthermore, in FIG. 4, the MOS transistor that forms the switching transistor (T9), a coil (L), a diode (D), a capacitor (C) and a switching unit (SWU) form a booster circuit unit. The switching unit (SWU) turns the MOS transistor (T9) on and off under the control of the constant current control unit (CIU) so as to generate a desired voltage.

In the conventional LED driving circuit shown in FIG. 4, the constant current control unit (CIU) determines short circuiting or disconnection for each channel (six channels in FIG. 4), and at the same time, controls the switching unit (SWU) so that a constant current (a current of 20 mA in FIG. 4) proportional to the current (Io) flowing through the resistor (Ro) flows through each channel. As a result, the group of light emitting diodes (GLED) connected to each channel can be driven with a desired constant current. In FIG. 4, for example, the groups of light emitting diodes (GLED) connected to four channels of the LED driver (LED-IC) can be driven with a constant current of 20 mA, respectively.

Here, the maximum constant current that is allowed to flow through each channel is 50 mA with the LED driver (LED-IC) shown in FIG. 4.

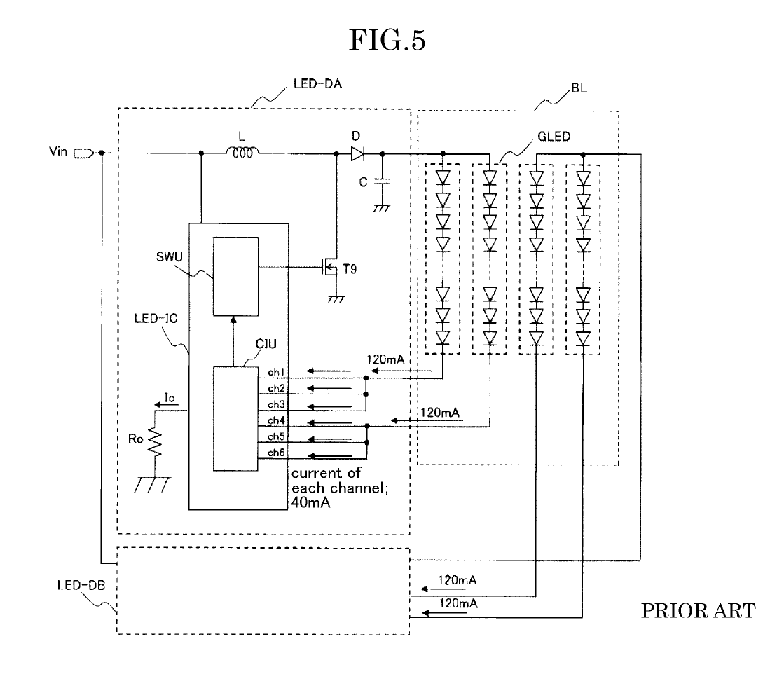

Therefore, it is necessary to use a number of LED drivers (LED-IC) in order to drive the group of light emitting diodes (GLED) with a current of 50 mA or higher. As shown in FIG. 5, for example, three channels of the LED driver (LED-IC) are used for one group of light emitting diodes (GLED) in order to drive each group of light emitting diodes (GLED) with a current of 120 mA so that a current of 40 mA flows through each channel, and thus, it is necessary for a total current of 120 mA to flow through one group of light emitting diodes (GLED).

Accordingly, in the case where four groups of light emitting diodes (GLED) are driven with a current of 120 mA, respectively, it is necessary to use two LED drivers (LED-IC) to drive the four groups of light emitting diodes (GLED) in two systems. Therefore, two expensive LED driver ICs (LED driver (LED-IC) in FIGS. 4 and 5) are necessary, and such a problem arises that the material cost is high.

Thus, in the case where commercially available LED driver ICs are used to drive white light emitting diodes as the light source for LED backlight, two or more expensive LED driver ICs that are commercially available are required, as shown in FIG. 5, even if the number of white light emitting diodes is reduced in order to lower the cost, and therefore, such a problem arises that the cost cannot be lowered.

The present invention is characterized in that the current flowing through each channel of the LED driver IC is amplified externally to generate a current for driving the group of light emitting diodes (GLED) in the case where a commercially available LED driver IC is used to drive the white light emitting diodes as the light source for backlight.

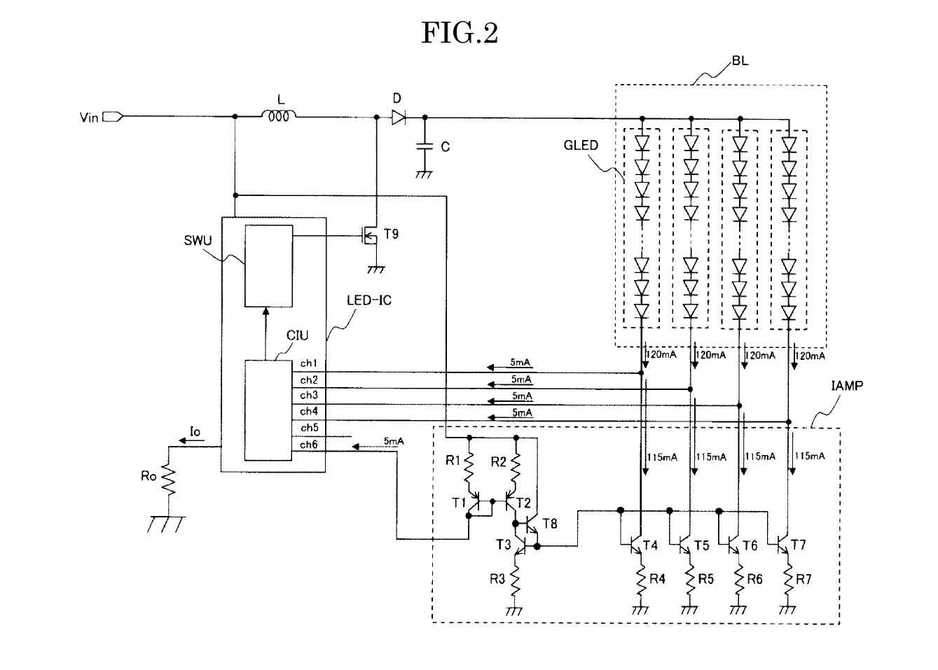

FIG. 2 is a circuit diagram showing the circuit structure of the LED driving circuit according to the first embodiment of the present invention.

In the LED driving circuit according to the present embodiment, the booster circuit unit has the same circuit structure as in the prior art, and the array of the groups of light emitting diodes (GLED) for the backlight (BL) has a structure in series that is the same as in the prior art.

The LED driving circuit according to the present embodiment has a current amplifying circuit (IAMP), and thus is different from the conventional LED driving circuit shown in FIGS. 4 and 5.

The present embodiment is characterized in that groups of light emitting diodes (GLED) are respectively connected to a number of channels of an LED driver (LED-IC) so that a current flows through each group of light emitting diodes (GLED), and at the same time, a current flows through the current amplifying circuit (IAMP), and in addition, the current amplifying circuit (IAMP) amplifies the current that flows through the LED driver (LED-IC) and allows a current to flow through the groups of light emitting diodes (GLED).

As shown in FIG. 2, the current amplifying circuit (IAMP) is formed of pnp-type bipolar transistors (hereinafter simply referred to as transistors T1, T2), npn-type transistors (T3 to T7) and resistors (R1 to R7).

Here, the pnp-type transistors (T1, T2) and the resistors (R1, R2) form a first current mirror circuit, and the npn-type transistors (T3 to T8) and the resistors (R3 to R7) form a multiple output type second current mirror circuit.

In FIG. 2, the current that flows through the pnp-type transistor (T1) in the first current mirror circuit flows through one channel (ch6) from among the number of channels of the LED driver (LED-IC).

In addition, the four groups of light emitting diodes (GLED) are respectively connected to the collectors of the npn-type transistors (T4 to T7) so that part of the current that flows through each of the four groups of light emitting diodes (GLED) flows through a channel (ch1 to ch4) from among the number of channels of the LED driver (LED-IC).

In general, the ratio of the currents that flow through the pair of transistors that form a current mirror circuit can be changed by changing the resistor ratio of the emitter resistances of the pair of transistors that form the current mirror circuit or by changing the area ratio of the emitter areas of the pair of transistors.

Accordingly, the resistor ratio of the resistor (R1) and the resistor (R2) as well as the resistor ratio of the resistor (R3) and the resistor (R4 to R7) are changed, that is to say, the mirror ratio (m) of the first current mirror circuit and the mirror ratio (n) of the second current mirror circuit are set to predetermined values so that the current value of the current that flows through the npn-type transistors (T4 to T7) can be set to (m×n) times greater than the current value of the current that flows through the pnp-type transistor (T1) (in other words, the amplification ratio of the current amplifying circuit (IAMP)).

Here, as shown in FIG. 2, when the current value of the current that flows through each channel of the LED driver LED-IC is 5 mA and the above-described (m×n) is set to 23, the current value of the current that flows through the npn-type transistor (T4 to T7) can be made 115 mA, and thus, it becomes possible to allow a current of 120 mA, which is the sum of a current of 5 mA that flows through each channel of the LED driver (LED-IC) and a current of 115 mA that flows through the npn-type transistors (T4 to T7), to flow through each of the four groups of light emitting diodes (GLED).

Therefore, only one LED driver (LED-IC) is necessary, and thus, it is possible to form the LED driving circuit according to the present embodiment at a lower cost than the conventional LED driving circuit shown in FIG. 5.

### Second Embodiment

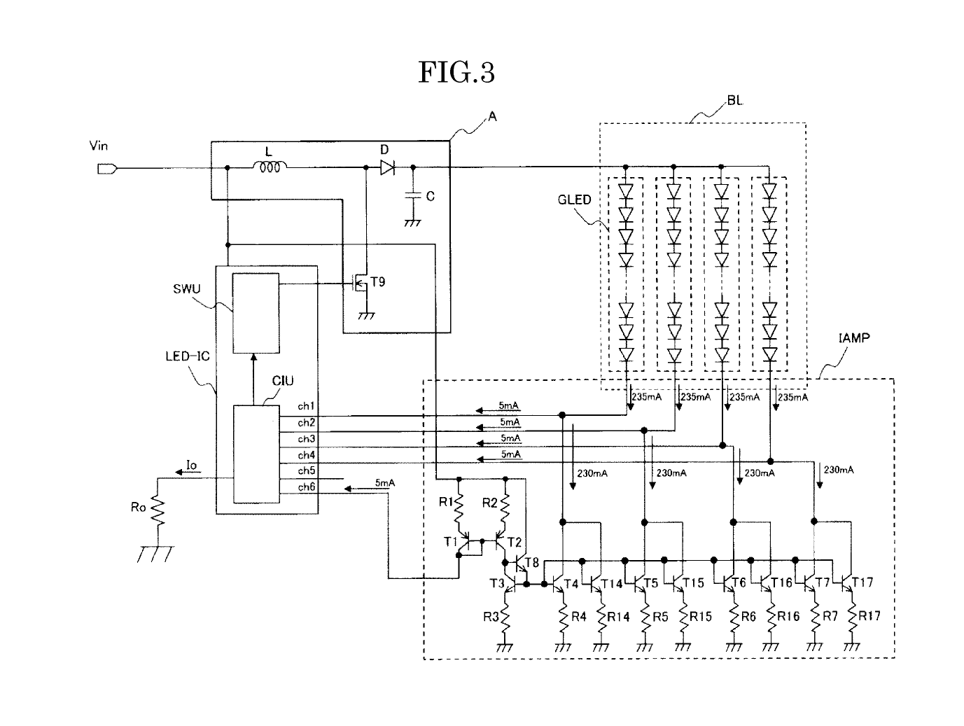

FIG. 3 is a circuit diagram showing the circuit structure of the LED driving circuit according to the second embodiment of the present invention.

In the LED driving circuit according to the present embodiment, a further greater current is required as the current that flows through each of the four groups of light emitting diodes (GLED), and in this embodiment, npn transistors (T14 to T17) are connected to npn transistors (T4 to T7) in parallel so that a current of which the amount is two times greater than that in the first embodiment can flow to the current amplifying circuit (IAMP) from each of the four groups of light emitting diodes (GLED).

In the present embodiment, a current of 5 mA flows through each channel of the LED driver (LED-IC), a current of 115 mA flows through each of the above-described npn transistors (T4 to T7), and a current of 115 mA flows through each of the npn transistors (T14 to T17), and therefore, a current of 235 mA flows through the four groups of light emitting diodes (GLED).

In addition, in the present embodiment, the current that flows through the groups of light emitting diodes (GLED) is high, and therefore, parts for allowing a large current to flow are used as parts within the region A in FIG. 3 (that is to say, the parts: MOS transistor (T9), coil (L), diode (D) and capacitor (C) in the booster circuit unit (CUB)).

Here, in the present embodiment, the number of npn transistors that are connected to the npn transistors (T4 to T7) in parallel is not limited to 1, and two or more npn transistors may be connected.

Though the embodiments where the present invention is applied to a liquid crystal display device are described in the above, the present invention is not limited to these, and the present invention can be applied to any display device having a backlight.

Though concrete embodiments according to the present invention made by the present inventor are described in the above, the present invention is not limited to these embodiments, and various modifications are possible as long as the gist of the invention is not deviated from.

What is claimed is:

1. A display device, comprising:
a display panel;
a backlight having light emitting diode columns; and
an LED driver IC for driving said light emitting diode columns, wherein
said light emitting diode columns are formed of a number of light emitting diodes,
said LED driver IC controls the voltage applied to said light emitting diode columns so that the current that flows through the light emitting diode column and is inputted into said LED driver IC becomes a predetermined constant current,
the display device further comprises a current amplifying unit for amplifying the reference current inputted into said LED driver IC and allowing the amplified reference current to flow through a light emitting diode column, and
the current inputted into said LED driver IC and the current amplified by said current amplifying unit flow through a light emitting diode column.

2. The display device according to claim 1, wherein
said LED driver IC boosts the input voltage, which is then inputted into one end of said light emitting diode columns,
said current amplifying unit comprises: a first current mirror circuit having a first transistor and a second transistor; and
a second current mirror circuit having a third transistor and a fourth transistor,
the other end of said light emitting diode columns is connected to said fourth transistor,
part of the current that flows through a light emitting diode column is inputted into said LED driver IC and the rest of the current that flows through the light emitting diode column flows through said fourth transistor,
the current that flows through said first transistor is inputted into said LED driver IC,
said second transistor allows a current that corresponds to the current that flows through said first transistor to flow through said third transistor,
a current that corresponds to the current that flows through said third transistor flows through said fourth transistor, and
said LED driver IC controls the voltage applied to said light emitting diode columns so that the current inputted into said LED driver IC through said first transistor and the current inputted into said LED driver IC through a light emitting diode column become constant currents.

3. The display device according to claim 1, further comprising:
a coil; and
a switching transistor for turning on and off the current that flows through said coil, wherein
said LED driver IC comprises a constant current control unit and a switching unit,
said switching unit turns on and off said switching transistor and boosts the input voltage, which is then inputted into one end of said light emitting diode columns,
said current amplifying unit comprises: a first current mirror circuit having a first transistor and a second transistor; and
a second current mirror circuit having a third transistor and a fourth transistor,
the other end of said light emitting diode columns is connected to said fourth transistor,
part of the current that flows through a light emitting diode column is inputted into said constant current control unit and the rest of the current that flows through the light emitting diode column flows through said fourth transistor,
the current that flows through said first transistor is inputted into said constant current control unit,
said second transistor allows a current that corresponds to the current that flows through said first transistor to flow through said third transistor,
a current that corresponds to the current that flows through said third transistor flows through said fourth transistor,
said switching unit turns on and off said switching transistor under the control of said constant current control unit and controls the voltage inputted into one end of said light emitting diode columns, and
said constant current control unit controls said switching unit so that the current inputted into said constant current control unit through said first transistor and the current inputted into said constant current control unit through a light emitting diode column become constant currents.

4. The display device according to claim 2, wherein I=m×n×Io is satisfied when the mirror ratio of said first current mirror circuit is m, the mirror ratio of said second current mirror circuit is n, the current that flows through said first transistor is Io, and the current that flows through said fourth transistor is I.

5. The display device according to claim 1, wherein
said LED driver IC boosts the input voltage, which is then inputted into one end of said light emitting diode columns,
said current amplifying unit comprises: a first current mirror circuit having a first transistor and a second transistor; and
a second current mirror circuit having a third transistor and fourth to (4+k)th transistors that are connected in parallel when k is an integer of 1 or more,
the other end of said light emitting diode columns is connected to said fourth to (4+k)th transistors,
part of the current that flows through a light emitting diode column is inputted into said LED driver IC and the rest of the current that flows through the light emitting diode column flows through said fourth to (4+k)th transistors,
the current that flows through said first transistor is inputted into said LED driver IC,
said second transistor allows a current that corresponds to the current that flows through said first transistor to flow through said third transistor,
a current that corresponds to the current that flows through said third transistor flows through said fourth to (4+n)th transistors, and
said LED driver IC controls the voltage applied to said light emitting diode columns so that the current inputted into said LED driver IC through said first transistor and the current inputted into said LED driver IC through the light emitting diode column become constant currents.

6. The display device according to claim 1, further comprising:
a coil; and
a switching transistor for turning on and off the current that flows through said coil, wherein
said LED driver IC comprises a constant current control unit and a switching unit,
said switching unit turns on and off said switching transistor and boosts the input voltage, which is then inputted into one end of said light emitting diode columns,
said current amplifying unit comprises: a first current mirror circuit having a first transistor and a second transistor; and
a second current mirror circuit having a third transistor and fourth to (4+k)th transistors that are connected in parallel when k is an integer of 1 or more,
the other end of said light emitting diode columns is connected to said fourth to (4+k)th transistors,
part of the current that flows through a light emitting diode column is inputted into said constant current control unit and the rest of the current that flows through the light emitting diode column flows through said fourth to (4+k)th transistors,
the current that flows through said first transistor is inputted into said constant current control unit,
said second transistor allows a current that corresponds to the current that flows through said first transistor to flow through said third transistor,
a current that corresponds to the current that flows through said third transistor flows through said fourth to (4+n)th transistors,
said switching unit turns on and off said switching transistor under the control of said constant current control unit and controls the voltage inputted into one end of said light emitting diode columns, and
said constant current control unit controls said switching unit so that the current inputted into said constant current control unit through said first transistor and the current inputted into said constant current control unit through a light emitting diode column become constant currents.

7. The display device according to claim 5, wherein I=m×n×k×Io is satisfied when the mirror ratio of said first current mirror circuit is m, the mirror ratio of said second current mirror circuit is n, the current that flows through said first transistor is Io, and the current that flows through said fourth transistor is I.

8. The display device according to claim 3, wherein I=m×n×Io is satisfied when the mirror ratio of said first current mirror circuit is m, the mirror ratio of said second current mirror circuit is n, the current that flows through said first transistor is Io, and the current that flows through said fourth transistor is I.

9. The display device according to claim 6, wherein I=m×n×k×Io is satisfied when the mirror ratio of said first current mirror circuit is m, the mirror ratio of said second current mirror circuit is n, the current that flows through said first transistor is Io, and the current that flows through said fourth transistor is I.
